(19) United States
(12) Patent Application Publication
(10) Pub. No.: US 2018/0172220 A1
(43) Pub. Date: Jun. 21, 2018

(54) ILLUMINATION DEVICE HAVING PHOSPHOR WHEEL

(71) Applicant: OSRAM GmbH, Munich (DE)

(72) Inventors: Jasmin Muster, Heidenheim (DE); Norbert Haas, Langenau (DE)

(21) Appl. No.: 15/814,453

(22) Filed: Nov. 16, 2017

(30) Foreign Application Priority Data
Dec. 16, 2016 (DE) 10 2016 225 361.1

(51) Int. Cl. F21K 9/64; F21K 9/68; F21V 13/08; F21S 41/141

(52) U.S. Cl. CPC F21K 9/64; F21K 9/68; G01N 2021/9511; F21S 41/141; F21V 13/08

(57) ABSTRACT

An illumination device is provided. The illumination device includes a rotatable phosphor wheel, which is at least regionally provided with phosphor for converting primary light into secondary light, a primary light generator configured to generate at least one useful primary light beam incident on the phosphor wheel, and at least one measuring device configured to measure a measured variable which can be influenced by the phosphor and to determine damage of the phosphor on the basis of measured data of the at least one measuring device.

### CROSS-REFERENCE TO RELATED APPLICATION

This application claims priority to German Patent Application Serial No. 10 2016 225 361.1, which was filed Dec. 16, 2016, and is incorporated herein by reference in its entirety.

### TECHNICAL FIELD

Various embodiments relate generally to an illumination device, having a rotatable phosphor wheel, which is at least regionally provided with phosphor for converting primary light into secondary light, and a primary light generating unit for generating at least one useful primary light beam incident on the phosphor wheel. Various embodiments also relate generally to a method for operating an illumination device, wherein a phosphor wheel, which is at least regionally provided with phosphor for converting primary light into secondary light, is rotated and at least one useful primary light beam incident on the phosphor wheel is generated. Various embodiments are applicable to headlights, e.g. to vehicle headlights.

### BACKGROUND

US 2012/0327679 A1 discloses a headlight, which contains a light-emitting section for emitting light upon incidence of laser light. A position of the light-emitting section can be changed by changing a position or an angle in which the light-emitting section is provided.

U.S. Pat. No. 9,115,873 B2 discloses an illumination device, which can suppress a reduction of its light yield and a shortening of its service life. The illumination device includes a fluorescence element, which is irradiated using laser light emitted by a semiconductor laser and emits secondary light, a rotation mechanism, which rotates the fluorescence element, and a reflecting element, which reflects the secondary light emitted by the fluorescence element outward.

### SUMMARY

An illumination device is provided. The illumination device includes a rotatable phosphor wheel, which is at least regionally provided with phosphor for converting primary light into secondary light, a primary light generator configured to generate at least one useful primary light beam incident on the phosphor wheel, and at least one measuring device configured to measure a measured variable which can be influenced by the phosphor and to determine damage of the phosphor on the basis of measured data of the at least one measuring device.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a side view of a sketch of an illumination device having a phosphor wheel; and

FIG. 2 shows a top view of a phosphor ring of the phosphor wheel.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

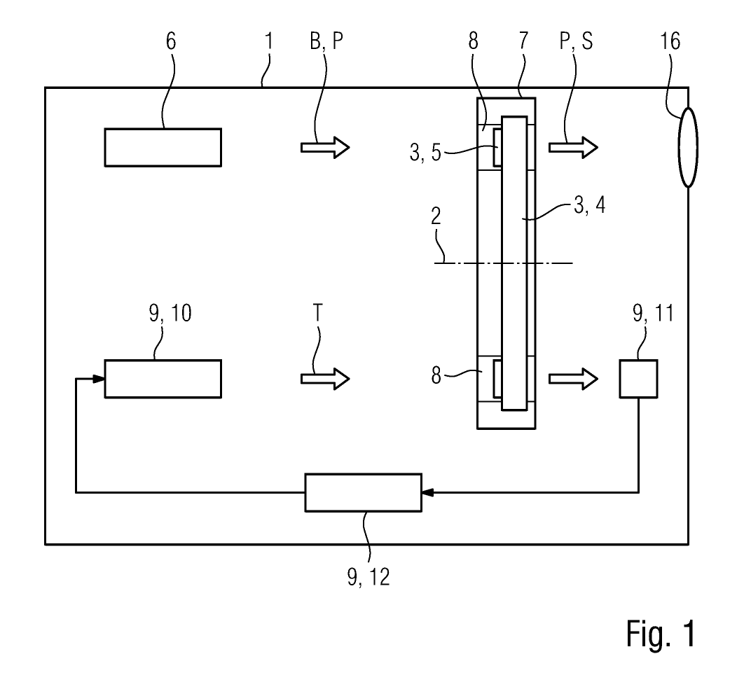

FIG. 1 shows a side view of a sketch of an illumination device 1 having a phosphor wheel 3 rotatable about a wheel or rotational axis 2. The phosphor wheel 3 has a light-transmissive carrier in the form of a transparent sapphire disk 4. A phosphor ring 5, for example, having or made of Ce:YAG as the phosphor, is applied to a front side of the sapphire disk 4.

The illumination device 1 furthermore has a primary light generating unit in the form of at least one first laser 6, which emits a useful primary light beam B made of blue primary light P of a wavelength between 405 nm and 460 nm onto the phosphor ring 5. The primary light P incident on the phosphor ring 5 is partially converted into yellow secondary light S. In the transmitting arrangement shown, a blue-yellow or white mixed light is emitted as useful light P, S from a rear side of the phosphor ring 5. The useful light P, S passes through the sapphire disk 4 and is furthermore decoupled by means of a decoupling optical unit 16 from the illumination device 1.

The phosphor wheel 3 is housed in a housing 7, which has multiple windows 8 for light transmission.

The illumination device 1 furthermore has a measuring unit 9 having a test light generating unit in the form of a second laser 10. The second laser 10 emits a test light beam T onto the phosphor ring 5. The test light beam T is incident on the phosphor ring 5 disjointedly from the useful primary light beam B.

The light of the test light beam T can be, for example, primary light P, light at least similar to the secondary light S, or another light. A light sensor 11 of the measuring unit 9 is located on the other side of the phosphor ring 5, i.e., facing toward its rear side.

The illumination device 1 additionally has an analysis unit 12, which is configured to analyze the measured data of the light sensor 11, in order to determine damage of the phosphor ring 5. The analysis unit 12 can represent a part of the measuring unit 9 or at least the illumination device 1. In various embodiments, the analysis unit 12 enables a position of the damage on the phosphor ring 5 to be determined, for example, its boundaries in relation to an angle position.

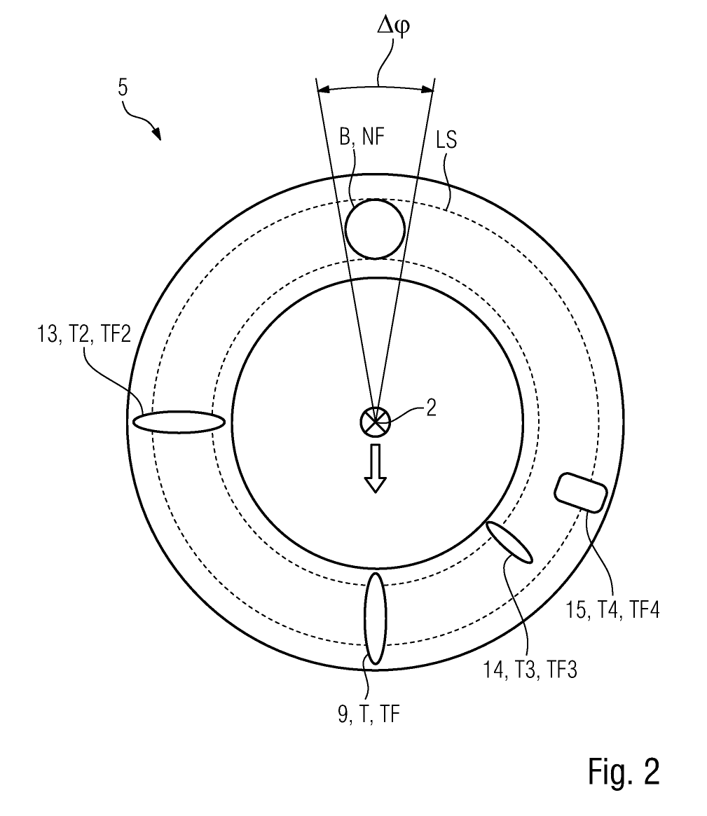

FIG. 2 shows a top view of the phosphor ring 5, which is arranged concentrically to the rotational axis 2. In the region of the phosphor ring 5, in which the useful primary light beam B strikes or is incident, a useful light spot NF—circular here solely by way of example—is formed. A test light spot TF is generated where the test light beam T is disjointedly incident thereto on the phosphor ring 5. While in one variant the light beams B, T remain stationary, the phosphor wheel 3 having the phosphor ring 5 rotates away under them, so that upon time integration of the useful light spot NF, a corresponding light track LS is generated on the phosphor ring 5.

The test light spot TF also overlaps the light track LS, and does so completely here in the radial direction in relation to the rotational axis 2. In other words, the test light spot TF extends at least over the entire height of the light track LS.

During operation of the measuring unit 9, damage of the phosphor ring 5 can be determined at all regions which are irradiated by the test light beam T. If the test light beam T is, for example, primary light P or light other than primary light P or secondary light S, the light sensor 11 will only record a small measured signal. In contrast, if the phosphor ring 5 is damaged, the test light beam T will be transmitted more strongly, which results in a noticeably increased measured signal. The increased measured signal can be recognized by the analysis unit 12 as damage and can be associated with at least one angle position and/or one angle range Δφ on the phosphor ring 5.

As one possible action, whenever the angle range of the phosphor ring 5 associated with the damage enters the range of the useful primary light beam B or the useful light spot NF, the useful primary light beam B can be dimmed or even shut down. The dimming can be carried out by reducing a laser power and/or by widening the useful light spot NF. Alternatively, at least whenever this angle range Δφ enters the range of the useful primary light beam B, the phosphor wheel 3 and therefore also the phosphor ring 5 can be offset radially and/or laterally, as indicated by the broad arrow. The useful light spot NF can thus optionally be guided around the damaged region. In various embodiments, the phosphor wheel 3 can be permanently laterally offset.

In addition to the measuring unit 9, further measuring units 13, 14, 15, which are light-based here, can also be provided, which generate, by means of corresponding test light beams T2, T3, T4, isolated and/or disjointed light spots TF2, TF3, TF4 on the phosphor ring 5. It is thus made possible to check damage of the phosphor ring 5 determined on the basis of measured data of a measuring unit (for example, the measuring unit 9) by way of measured data of the other measuring units 13, 14, and/or 15.

The test light beams T2, T3, T4 can emit identical light, for example, primary light P, or different light, for example, primary light P or secondary light S. Also, as shown, the shapes and sizes of at least two light spots TF, TF2 can correspond. Moreover, the shapes and sizes of at least two light spots TF and/or TF2, TF3, TF4 can be different. In addition, a radial focal point spacing in relation to the rotational axis 2 of at least two light spots TF and/or TF2, TF3, TF4 can be different.

Various embodiments at least partially overcome the disadvantages of the prior art and provide an illumination device of the type mentioned at the outset, which enables improved recognition of damage of the phosphor.

Various embodiments provide an illumination device, having a rotatable phosphor wheel, which is at least regionally provided with phosphor for converting primary light into secondary light, and a primary light generating unit for generating at least one useful primary light beam which is incident or can be irradiated onto the phosphor wheel, wherein the illumination device furthermore has at least one measuring unit for measuring a measured variable which can be influenced by the phosphor and is configured for the purpose of determining damage of the phosphor and/or checking for damage of the phosphor on the basis of measured data of the at least one measuring unit.

This illumination device results in the effect that damage of the phosphor wheel is determinable particularly reliably. An exit of a nonconverted useful primary light beam from the illumination device can thus be prevented particularly reliably, which in turn increases protection for an observer, for example, with respect to eye safety. Such an illumination device is also implementable in a space-saving manner.

The illumination device can be a headlight, for example a vehicle headlight. However, the headlight can also be used for the purpose of general illumination, outside illumination, safety illumination, stage illumination, special illumination, etc.

The phosphor wheel is rotatable about a rotational axis and can be shaped, for example, circular or ring-shaped. A rotational frequency or speed can be, for example, between 1 Hz and 200 Hz or even more.

The phosphor is capable of at least partially converting or transforming incident primary light into secondary light of a different wavelength. If multiple phosphors are provided, they can generate secondary light of wavelengths different from one another. For example, blue primary light can be converted by means of a phosphor into green, yellow, orange, or red secondary light. For at least partial conversion of blue primary light into yellow secondary light, for example, yellow Ce:YAG phosphor can be used.

In the case of only partial wavelength conversion or wavelength transformation, a mixture of secondary light and nonconverted primary light is emitted by the phosphor body, which can be used as useful light. For example, white light can be generated from a mixture of blue, nonconverted primary light and yellow secondary light. However, a full conversion is also possible, in which the primary light is either no longer present or is present only in a negligible component in the useful light. A degree of conversion is dependent, for example, on a thickness and/or a phosphor concentration of the phosphor. If multiple phosphors are provided, secondary light components of different spectral compositions can be generated from the primary light, for example, yellow and red secondary light. The red secondary light may be used, for example, to give the useful light a warmer color tone, for example, so-called “warm white”. If multiple phosphors are provided, at least one phosphor may be capable of once again wavelength-converting secondary light, for example, green secondary light into red secondary light. Such light which is once again wavelength-converted from secondary light may also be referred to as “tertiary light”.

Due to the rotation of the phosphor wheel, it rotates away under the useful primary light beam, so that the useful primary light beam illuminates a closed track (“light track”) e.g. on the phosphor wheel. The useful primary light beam can be location-invariable in relation to the phosphor wheel.

The phosphor wheel can be uniformly provided with at least one phosphor, for example, for conversion into yellow secondary light. The phosphor wheel can alternatively have multiple segments or sectors distributed on the light track, which have different properties. Thus, different sectors can have different phosphors (for example, for conversion into secondary light of different colors such as red, green, blue, etc.), can be designed as a transmission region, can be designed as reflective regions, etc.

The phosphor wheel can be housed in a reflector, e.g. so that a light spot presently generated by the at least one useful primary light beam is located in the region of a focal point or focal region of the reflector.

The phosphor wheel can be accommodated or housed in a housing for its protection. The housing can have one or more windows—optionally covered in a light-transmissive manner.

The primary light generating unit can have one or more light sources for generating the at least one useful primary light beam. The at least one light source can be a semiconductor light source, for example, a light emitting diode (LED) or a laser diode. The primary light can thus be laser light.

The primary light emitted by the at least one light source can be, for example, UV light or blue light. The blue light can in particular have a wavelength between 405 and 460 nm.

A useful primary light beam is used for generating useful light emitted by the illumination device for illumination purposes. The useful light (for example, blue-yellow mixed light) can be emitted in a transmitting arrangement from the side of the phosphor wheel which faces away from the side of the incident useful primary light beam. In a reflecting arrangement, the useful light can be emitted from the side of the phosphor wheel on which the useful primary light beam is also incident. In the transmitting arrangement, the phosphor can be applied to a light-transmissive underlay (for example, made of plastic, glass, or sapphire), in the reflecting arrangement to a reflective underlay.

For decoupling the useful light from the illumination device, a (“decoupling”) optical unit can be connected optically downstream of the phosphor wheel. The decoupling optical unit can have, for example, at least one reflector, one lens, one optical waveguide, one aperture, etc.

In one refinement, the measured variable which can be influenced by the phosphor is a measured variable measurable in a contactless manner, e.g. a measured variable based on a wave propagation.

The measured variable can be an optical measured variable (for example, a brightness, a luminous flux, a colorimetric locus, etc.), an acoustic measured variable (for example, a sound level), a non-optical radiation measured variable (such as an amplitude or an intensity of non-optical radiation), etc. An optical measured variable can be a UV measured variable, a measured variable relating to a visible spectral range, and/or an IR measured variable. The acoustic measured variable can be an ultrasound measured variable. A non-optical radiation measured variable can be a measured variable related to a radio radiation and/or a terahertz radiation. The phosphor can influence the measured variable, for example, by way of its conversion property and/or its absorption properties (for example, for optical waves, radio waves, terahertz waves, acoustic waves, etc.).

The at least one measuring unit can have in each case at least one corresponding sensor or detector, e.g. a sensor operating in a contactless manner. The at least one sensor may include, for example, at least one light sensor (optionally different light sensors, which are sensitive to different spectral ranges), at least one radio sensor, at least one terahertz sensor, and/or at least one acoustic sensor. A light sensor can be a UV sensor or an IR sensor.

The at least one measuring unit may in each case include at least one transmitting unit or emitter oriented on the phosphor wheel, e.g. for emitting waves such as optical waves (light), terahertz waves, radio waves, acoustic waves, etc. The transmitting unit can have a light source, a terahertz transmitter, a radio transmitter, a US converter, etc.

The measuring unit utilizes the fact that a signal received at a sensor behaves differently depending on whether the phosphor is damaged (for example, has cracks or is even locally chipped off) or not. For example, a transmissibility of the phosphor for radiation can be significantly higher in the region of damage than in an undamaged region. A sensor can measure radiation passing through the phosphor wheel or radiation reflected therefrom. Sensor and transmitting unit can be arranged for a measuring unit in an arrangement which is transmissive or reflective in relation to the phosphor wheel. Different measuring units can have identical or different arrangements of sensor and transmitting unit.

In one refinement, the transmitting unit and the sensor are configured to carry out measurements continuously (for example, in continuous wave operation) and/or cyclically (for example, at a sufficiently high clock frequency).

The measured data (i.e., values of the measured variable(s) measured by the at least one measuring unit) can thus be used to determine damage (or non-damage) of the phosphor. This can be performed by means of a correspondingly configured analysis unit. The analysis unit can represent a part of the illumination device and/or can be integrated in the illumination device (also solely functionally) or can be a unit which is connected thereto but is separate.

In one refinement, a position of the damage on the phosphor wheel is determinable. This results in the effect that the damage only has to be reacted to by local adaptation of operation of the illumination device. In the sections of the light track outside the damage, the illumination device can be operated uninfluenced by the damage in many cases. The position of the damage can be an angle position in relation to the rotational axis and/or a radial position (spacing from the rotational axis). For example, to determine the angle position of the damage, the fact can be utilized that a unique correlation between the phosphor region measured at a certain point in time and the associated time range, within which the phosphor region passes through the respective measuring unit, exists because of the rotational frequency of the phosphor wheel, which is known at all times.

In one refinement, at least one action can be triggered with determination of damage, for example, an output of a message to a user and/or a shutdown of the illumination device. The action can also provide an increase of a speed of the phosphor wheel, e.g. in the case of a complete shutdown of the useful primary light beam, to reduce a duration of the off state.

In one embodiment, the illumination device is configured to offset the phosphor wheel or its rotational axis to the side or laterally at least locally at a location of the determined damage upon determination of damage of the phosphor. The light track on the phosphor wheel is thus also offset, and so that it leads past the damage.

The fact that the phosphor wheel can be offset at least locally may include that the phosphor wheel is only (locally) offset (“local offset”) from its original rotational axis for the damaged region (can also be referred to as the damaged zone). For example, the rotational axis can be offset shortly before reaching an angle section associated with the damaged region and then be reset again. Alternatively, the at least local offsetting capability may include the phosphor wheel being offset for an entire revolution (“lasting offset”).

Alternatively or additionally, the beam axis of the useful primary light beam can be able to be offset at least locally so that the useful primary light beam avoids the damaged region or is no longer incident on the damaged region, since it is guided around the damaged region. This can be performed e.g. by an offset of the useful primary light beam radially in relation to the rotational axis in an angle region of the phosphor wheel associated with the damage.

In another embodiment, the illumination device is configured to dim (i.e., to reduce its brightness or luminosity at least locally) at least the at least one useful primary light beam, upon determination of damage of the phosphor, at least locally at a location of the determined damage. The effect is thus achieved that an intensity of a useful primary light beam passing unobstructed through the damaged region can be reduced, without having to adapt a rotation of the phosphor wheel.

The fact that the phosphor wheel is at least locally dimmable may include the phosphor wheel only being dimmed for this purpose at the damaged region (“local dimming capability”), for example, a light density is reduced shortly before reaching an angle section associated with the damaged region and then increased again. Alternatively, the at least local dimming capability may include the phosphor wheel being dimmed for an entire revolution (“lasting dimming capability”).

The dimming may include a power reduction of the useful primary light beam, a widening of the useful primary light beam, or even a shutdown of the useful primary light beam. In various embodiments, the useful primary light beam can be dimmed more strongly the larger and/or more severe the determined damage is. The useful primary light beam can be shut down or widened extremely e.g. upon exceeding a predefined limiting value of an error signal.

In a further embodiment, the at least one useful primary light beam is constructed like pixels in cross section (“pixelated”) and can be shut down pixel by pixel locally at the location of the determined damage. This enables a particularly fine delimitation of the damaged region and therefore operation of the illumination device which is influenced particularly little by the damage. In various embodiments, this can take place without influencing the phosphor wheel and the useful primary light beam. For the pixelation of the useful primary light beam, a micromirror array (for example, DMD) or another optical modulator which acts locally like pixels, can be provided between the primary light generating unit and the phosphor wheel. For example, those mirror actuators of a micromirror array, which would deflect incident primary light onto the damaged region in the non-pivoted state, can temporarily be pivoted to deflect the primary light incident thereon adjacent to the phosphor wheel.

In still another embodiment, the illumination device and/or the at least one test unit thereof has at least one test light generating unit for generating at least one test light beam, which is incident disjointedly from the useful primary light beam on the phosphor wheel, and additionally has at least one sensor in the form of a light sensor for the at least one test light beam. Damage can be determined reliably and particularly cost-effectively by way of the use of light. A disjointed arrangement can be understood in general as an arrangement which does not or does not noticeably overlap on the phosphor wheel. The light spots thus generated accordingly do not or do not noticeably overlap.

In one embodiment thereof, the test light beam is a test primary light beam. The test light thus has the properties of the light of the useful primary light beam, e.g. its spectral composition. This embodiment enables a particularly reliable determination of damage and additionally may be implemented easily.

The primary light may include e.g. radiation in the blue wavelength range (from 405 to 460 nm). In the undamaged normal state, similarly to the effect of the useful primary light beam, at least partial conversion into secondary light and scattering of the nonconverted component on the phosphor also takes place by means of the test primary light beam. In the event of damage of the phosphor (for example, due to missing or cracked phosphor), a changed signal results at the light sensor. A photodiode (for example, provided with a blue transmission filter) can be used, for example, as the light sensor.

The test primary light beam can be generated by means of a test light generating unit, which has separate primary light sources. Therefore, in one embodiment the test light generating unit is a unit different from the primary light generating unit. In this embodiment, the test primary light beam is settable particularly flexibly due to its independent generation.

In an alternative embodiment, the test light generating unit corresponds to the primary light generating unit and the test light beam is a light beam branched off from the useful primary light beam. This embodiment is implementable particularly cost-effectively. For example, a noticeably weaker test primary light beam can be branched off by means of an optical deflection unit from the useful primary light beam. Such a measuring unit can thus have a light sensor, but does not need to have a separate transmitting unit.

In one refinement, the test light beam is a test secondary light beam, for example, made of yellow light. The test secondary light beam at least approximately has properties of the secondary light converted by the phosphor, in particular the spectral composition thereof, e.g. wavelength. This refinement also enables a particularly reliable determination of damage and may be implemented easily. In the undamaged normal state, only scattering of the secondary light takes place on the phosphor. Upon damage of the phosphor (for example, due to missing or cracked phosphor), a changed signal results. A photodiode (for example, provided with a yellow transmission filter) can be used, for example, as the light sensor.

In still another refinement, the test light beam is a light beam which includes light from a different spectral range than the primary light and the secondary light, optionally also UV light or IR light.

Furthermore, in one embodiment, a test light spot of at least one test light beam, which can be generated on the phosphor wheel, has a narrower shape in at least one direction in relation to a useful light spot of at least one useful primary light beam. Damage of the phosphor may thus be determined particularly accurately with respect to location. In a refinement thereof, the test light spot is narrower in the circumferential direction or along the light track than the useful light spot.

The useful light spot can have, for example, a diameter between 10 nm and several millimeters (for example, at most 10 mm).

In another embodiment, the illumination device has multiple measuring units. This enables a particularly reliable determination of damage on the basis of multiple measurements which can be carried out independently of one another. In one embodiment, damage of the phosphor determined by a measuring unit can thus be checked (i.e., confirmed or discarded) by at least one other measuring unit. This can also be carried out by means of the analysis unit.

In one refinement, at least two of the measuring units are measuring units of different types, for example, on the one hand, based on a light-based measurement and, on the other hand, based on a measurement by means of acoustic waves. This may enable a particularly reliable determination of damage.

In another embodiment, the illumination device has multiple light-based measuring units, by means of which multiple test light beams can be generated, which can be radiated disjointedly from one another onto the phosphor wheel. These may be implemented particularly simply and cost-effectively. At least two light-based measuring units can use light of different spectral compositions (for example, different wavelengths) as test light. Alternatively or additionally, at least two light-based measuring units can use light of identical spectral composition as test light.

In another embodiment, a shape, a size, and/or a radial focal point spacing in relation to a rotational axis of light spots from at least two light beams differ.

The object can thus in particular have a rotating phosphor wheel having at least one phosphor region, wherein measuring units (monitoring units) are arranged along a revolving (co-rotating) surface line of the phosphor wheel, which can detect a change of the phosphor and then either (a) reduce the laser radiation, shut down the laser radiation, or induce a change of the pixelation for the period of time in which the damaged point passes through a light spot of a useful primary light beam, or (b) move the phosphor wheel laterally enough that the light spot is now located outside the damaged region.

The object is also achieved by a method for operating an illumination device, wherein a phosphor wheel, which is at least regionally provided with phosphor for converting primary light into secondary light, is rotated, at least one useful primary light beam incident on the phosphor wheel is generated, at least one measured variable which can be influenced by the phosphor is measured, and a presence (or similarly an absence) of damage is checked on the basis of the measured variables.

The method can be designed similarly to the illumination device and results in the same effects.

In one embodiment—in case of a presence of damage—a position of the damage and/or a damaged region of the phosphor is thus determined and then an incidence of the useful primary light beam on the damaged region is prevented or is enabled with a locally reduced luminosity or is entirely prevented. The prevention can be achieved, for example, by temporarily shutting down the useful primary light beam at the damaged region or by guiding the useful primary light beam around the damaged region.

In general, “a”, “one”, etc. can be understood as a single or a plurality, in particular in the sense of “at least one” or “one or more” etc., as long as this is not explicitly precluded, for example, by the expression “precisely one”.

A numeric specification may also include precisely the specified number and also a routine tolerance range, as long as this is not explicitly precluded.

### LIST OF REFERENCE NUMERALS

illumination device 1
rotational axis 2
phosphor wheel 3
sapphire disk 4
phosphor ring 5
first laser 6
housing 7
window 8
measuring unit 9
second laser 10
light sensor 11
analysis unit 12
measuring unit 13
measuring unit 14
measuring unit 15
decoupling optical unit 16
useful primary light beam B
light track LS
useful light spot NF
primary light P
secondary light S
test light beam T
test light beam T2
test light beam T3
test light beam T4
test light spot TF
test light spot TF2
test light spot TF3
test light spot TF4
angle range Δφ

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An illumination device, comprising:
a rotatable phosphor wheel, which is at least regionally provided with phosphor for converting primary light into secondary light;
a primary light generator configured to generate at least one useful primary light beam incident on the phosphor wheel; and
at least one measuring device configured to measure a measured variable which can be influenced by the phosphor and to determine damage of the phosphor based on measured data of the at least one measuring device.

2. The illumination device of claim 1,
wherein the illumination device is configured, upon determination of damage of the phosphor, to laterally offset the phosphor wheel at least locally at a location of the determined damage.

3. The illumination device of claim 1,
wherein the illumination device is configured, upon determination of damage of the phosphor, to dim at least the at least one useful primary light beam at least locally at a location of the determined damage.

4. The illumination device of claim 3,
wherein the at least one useful primary light beam is constructed like pixels and can be shut down pixel by pixel locally at the location of the determined damage.

5. The illumination device of claim 1, further comprising:
at least one test light generator configured to generate at least one test light beam, which is incident disjointedly from the useful primary light beam on the phosphor wheel, and has at least one sensor in the form of a light sensor for the at least one test light beam.

6. The illumination device of claim 5,
wherein the test light beam is a test primary light beam.

7. The illumination device of claim 5,
wherein a test light spot of at least one test light beam, which can be generated on the phosphor wheel, has a narrower shape in at least one direction in relation to a useful light spot of at least one useful primary light beam.

8. The illumination device of claim 5,
wherein the test light generator corresponds to the primary light generator and the test light beam is a light beam branched off from the useful primary light beam.

9. The illumination device of claim 5,
wherein the test light generator is a device different from the primary light generator.

10. The illumination device of claim 1,
wherein the illumination device has multiple measuring devices.

11. The illumination device of claim 10,
wherein the illumination device has multiple light-based measuring devices, by means of which multiple test light beams can be generated, which can be radiated disjointedly from one another onto the phosphor wheel.

12. The illumination device of claim 11,
wherein at least one of a shape, a size, or a radial focal point spacing in relation to a rotational axis of test light spots of at least two test light beams differ.

13. The illumination device of claim 10,
wherein the illumination device is configured to check damage of the phosphor determined based on measured data of a measuring device by way of measured data of at least one other measuring device.

14. A method for operating an illumination device, the method comprising:
rotating a phosphor wheel, which is at least regionally provided with phosphor for converting primary light into secondary light;
generating at least one useful primary light beam incident on the phosphor wheel;
measuring at least one measured variable which can be influenced by the phosphor; and
checking damage of the phosphor based on the measured variables.

15. The method of claim 14,
wherein a position of the damage of the phosphor is determined based on the measured variables, and an incidence of the useful primary light beam on the damaged region with a locally reduced luminosity is thus enabled or prevented.
